(19) United States
(12) Patent Application Publication
(10) Pub. No.: US 2005/0177427 A1
(43) Pub. Date: Aug. 11, 2005

(54) Incentives based upon active key sniffing

(76) Inventors: Jeff Mount, Saint Petersburg, FL (US); Jim Clack, Saint Petersburg, FL (US); Steve Greenfield, Palm Harbor, FL (US); Will Gardenswartz, Laguna Beach, CA (US)

Correspondence Address: NEIFELD IP LAW, PC, 4813-B EISENHOWER AVENUE, ALEXANDRIA, VA, 22304, US

(21) Appl. No.: 10/973,456

(22) Filed: Oct. 27, 2004

Related U.S. Application Data
(60) Provisional application No. 60/514,016, filed on Oct. 27, 2003.

(51) Int. Cl. G06F 17/60

(52) U.S. Cl. 705/14

(57) ABSTRACT

A method and system for issuing incentives based on pressing certain mechanical or virtual keys on a POS system where such keys correspond to products, totals, sub-totals and other functions normally associated with a POS keyboard and the location of such keys are in a constant state of flux. A system and method for harvesting the information that describes the name and location of keys and using this information to issue incentives to a consumer at the POS terminal.

### CROSS REFERENCE TO RELATED CASES

This application claims priority to U.S. provisional application No. 60/514,016 filed Oct. 27, 2003. U.S. provisional application No. 60/514,016 is incorporated by reference.

### BACKGROUND OF THE INVENTION

1. Field of the Invention

This invention relates to inventory control and marketing.

Terms used in this application are defined below.

A sensor, in this application, is a device that produces a specified signal in response to a specified stimulus.

A touch screen, in this application, is a surface having sensors that respond to touching the screen.

An icon, in this application, is an image.

A key, in this application, may be either an icon on a touch screen or a mechanical key.

A touch screen icon, in this application, is an image on a touch screen.

An image touch screen, in this application, is a touch screen with different sensors associated with different icons appearing on the screen.

POS, in this application, means point of sale, which is the area where a consumer engages in transactions.

POS terminal, in this application, means point of sale terminal, which is an input output device for communicating consumer transaction information between a consumer and a store to a computer system associated with the store.

A signal, in this application, refers to data transmission, such as a binary datastream, and includes the type of data transmission that results from a person touching an icon on a touch sensitive image touch screen.

A POS terminal data signal, in this application, means a signal generated from the POS terminal, for example, a data signal containing data resulting from pressing an icon on an image screen.

A lookup table, in this application, is a table that enables hardware and software to convert the data signal generated received from the touch screen image to meaningful information, for example, by identifying either a product or an alphanumeric portion of a product identification corresponding to the data signal.

A product code, in this application, is a code associated with a product. For example, a product code may be a code assigned by a company, or by an industry standard, to a product.

A CID, in this application, is any identifier that is scanned, read, or otherwise entered into a computer or terminal to identify a consumer. A CID is also known as a consumer ID or a consumer identification. As used in this context, the term “consumer” includes households and/or other groups of people that use the same identifier. Each consumer may have multiple CIDs. Preferably, the CID is represented as a bar code so that it can be quickly scanned at checkout by a scanner although any other type of machine readable or non-machine readable implementations for storing or displaying identifications may be used, including magnetic strips, memory chips, and smart cards. Examples of CIDs include credit card numbers, debit card numbers, social security card numbers, driver's license numbers, license plate numbers, checking account numbers, street addresses, names, e-mail addresses, telephone numbers, frequent consumer card numbers, shopper card identifications (SCIDs), retina scans, biometric scan indicia (fingerprint, face recognition), shopper loyalty card numbers, or an identification code uniquely associated with the consumer or the consumer's household.

An incentive, in this application, means value offered to a consumer the receipt of which by the consumer is contingent upon the consumer entering into a specified transaction. An incentive includes a promotion, message, research invitation, or game piece.

A game piece, in this application, means a printed item offered by incentive local computer that can be used for a game that is currently being offered by a retail store. For example, the printed item may have a B5 on it for Bingo. Alternatively, it could have a different number for a different game. In addition, the incentive system randomizes the game pieces issued to each consumer.

Database, in this application, means-data organized in some format in a computer memory that can be accessed by an associated computer system. Such a concept is also referred to as a database management system. A database or database management system includes commercial database products such as the Microsoft Access and SQL server, as well as any set of files stored in computer memory that can be accessed by an associated computer system.

Value, in this application, means a good, a service, or a pecuniary interest including cash, check, credit, and conditional credit.

Transaction, in this application, means an exchange involving at least two legal entities. A purchase is a transaction.

Purchase, in this application, means a transaction involving at least two parties in which cash, check, charge or credit is exchanged for one or more goods or services.

Store identification, in this application, means an identification associated with a store that uniquely identifies that store.

Sniffer line, in this application, refers to a line that connects to or otherwise detects the digital data stream being transmitted from a POS terminal in a POS computer system. The sniffer line propagates the digital signal to an input of an incentive local computer.

Purchase data, in this application, includes data associated with purchases, product code for the product purchased, date of purchase, time of purchase, price of items purchased, and type of payment, typically, in association with a CID.

POS computer, in this application, refers a computer that operatively connects to at least once POS terminal.

A POS computer system, in this application, includes a POS computer and peripheral and input and output devices connected thereto, such as POS terminals, opticals, scanners, etc.

Incentive central computer, in this application, refers to a computer which is preferably owned by a legal entity, herein referred to as the marketing company. An incentive central computer preferably functions to determine whether to offer an incentive to a consumer; and transmits data for criteria for issuing incentives to an incentive local computer.

An incentive local computer, in this application, refers to a computer connectable to an incentive central computer via a network. Incentive local computer converts POS terminal data signals received on the sniffer line to meaningful- information, for example, by identifying either a product or an alphanumeric portion of a product identification corresponding to the data signal. An incentive local computer will thereafter recognize conditions for issuing incentives and, in turn, offer an incentive to a consumer when or after those conditions are met. Incentive central computer may also function to perform the functions of the incentive local computer.

Real time, in this application, refers to a time for offering incentives, wherein it is determined whether and which incentives to offer to a consumer while a consumer is determined to be at a POS terminal and then offering the consumer the determined incentives.

POS M central computer, in this application, refers to a central POS computer connectable to multiple POS computer systems.

Computer system M1, in this application, means a computer system including at least one POS computer, an associated POS M central computer, POS terminal, memory, input, and output devices. Preferably there are computer systems M1, M2, . . . Mn.

Retail store, in this application, refers to a store in which product services are sold to consumers. Examples of stores include quick service restaurants, convenience stores, retail clothing stores, supermarkets, petroleum stores, etc.

A retail chain of stores, in this application, refers to a plurality of stores in a chain of stores in which the equivalents of menu item vary or can be varied between each store in the chain of stores.

Sniff, in this application, refers to connecting to or otherwise detecting a digital data stream.

Price number, in this application, refers to a numerical value of 1, 2, 3, 4, 5, or 6. For example, price number 1 refers to the product price for a non-employee.

Transaction data means data associated with a transaction. For example, transaction data may include product purchase data, time and date data, CID, transaction terminal ID, store ID, etc.

2. Background Art

Keyboard monitoring software for monitoring which keys are depressed on a keyboard is known. See U.S. patent publication No. 20020036620. It is typically used to monitor activity of employees to measure productivity and to identify use of computers by employees that are prohibited by their employers.

Systems for maintaining a customer database using license plate scanning are known. See U.S. Pat. No. 6,374,240.

### BRIEF SUMMARY OF THE INVENTION

A problem identified by the inventors that is particularly relevant to fast food restaurants retail chain of stores, is that restaurants in the same retail chain of stores may change menus during the day, and different retail stores of the same retail chain of stores may have different menus. The menus are reflected in the configuration of image touch screens used in the POS terminals in these retail stores. The image touch screens have configurations of icons that may represent different products in different retail stores. In addition, each store may reconfigure its image touch screen to define different menus at different times of the day, such as a breakfast menu and a daytime menu. That is, the same image icon may represent purchase of an item of different products at different times of day or in different retail stores. The inventors recognize that the same problem can exist in any other retail chain of stores in which the equivalents of menu item vary or can be varied between each retail store in the chain. For example, convenience stores, retail clothing stores, supermarkets, petroleum stations, etc.

A related problem identified by the inventors is related to their realization that retail stores of a retail chain of stores often have different POS computer system hardware and software from one another. As a result, the inventors realized that implementing hardware and software in the various existing POS computer systems of the stores in the retail chain in order to implement storage and use of product purchase data, and generating incentives for such data, would have been inefficient.

Typically, in these types of stores, the relationships between the image touch screen icons and the products they represent are programmed so that the POS computer recognizes what is being purchased in response to each signal. The inventors recognized that these stores typically have no mechanism to store customer identification in association with an order, although these systems often provide some mechanism for reading a customer identification, such as a bar code reader, a magnetic card reader, or keypad input.

One aspect of the inventors' solution to the problem associated with identifying and storing items purchased in orders and customer identifications in various retail stores in a chain is to provide in each store hardware and software that can listen in on the data stream flowing between the image touch screen and the POS computer system, and then interpret that data read thereby as transaction data, including purchase data and preferably also price number data and CID data, using one or more lookup tables in the interpretation.

The lookup tables enable hardware and software to convert the data signal generated from touching a touch screen image to meaningful information, for example, by identifying either a product or an alphanumeric portion of a product identification corresponding to the data signal. The lookup tables can be configured differently for each retail store to reflect the correspondence of the image icons on the touch screen and corresponding products and services associated therewith in that particular store. The lookup tables or correspondences in a lookup table that are used can be time dependent, or can be otherwise synced to the POS system so that the image icon to product or service correspondence table at any given time represents the correspondence of the image icons on the touch screen and products and services associated therewith in that particular store. The lookup tables may be stored in a computer system distinct from the POS system, or may be integrated into the POS system, or both.

Preferably, the invention also includes a coordinating or POS M central computer that can distribute new lookup tables, lookup table time syncing times, and lookup table control information to the POS computer systems associated with the retail stores and controlling the lookup tables.

Preferably, the POS computer systems controlling the lookup tables also contain means, such as a modem or a NIC card, and associated telephone or network line, to communicate with the coordinating or POS M central computer.

Preferably, the invention includes a incentive central computer. The incentive central computer preferably receives the lookup tables from the POS M central computer. The incentive central computer preferably sends the lookup tables to a local incentive computer.

Preferably, the invention includes a local incentive computer. The incentive local computer receives lookup tables from the incentive central table via a network. The local incentive computer also uploads purchase data and associated customer identification data. Preferably, the local incentive computer includes means for analyzing that data and generating incentives. Preferably, the local incentive computer has means to respond to customer identifications by printing or displaying incentives, advisory messages, or instructions for providing product samples to customers identified.

Objects of the Invention

An object of this invention is to monitor transaction data generated in POS terminals that include image touch screens.

Another object of this invention is to identify customers purchasing items from POS terminals.

Another object of this invention is to identify product purchase information from signals generated in POS terminals, such as those including an image touch screen, reading associated customer identification information, and storing that product purchase information in association with the customer's identification information, such as a CID, in a computer database.

A further object of the invention is to use the stored customer's identification information in a computer database to generate incentives, product samples, and informational messages likely to be useful to the consumers, and to provide those incentives, samples, and messages to the consumers.

Another object of the invention is to issue incentives, promotions, messages, research invitations and game pieces based on pressing certain virtual or mechanical keys.

Another object of the invention is to harvest the information that describes the name and location of the keys.

Another object of the invention is to dynamically and accurately adjust the issuance of incentives, promotions, messages, research invitations and game pieces based on the new or reconfigured keyboard.

Another object of the invention is to issue incentives, promotions, messages, research invitations and game pieces based upon meeting a service level of failure to meet a service level.

Another object of the invention is to issue incentives, promotions, messages, research invitations and game pieces based on whether the customer drives up or walks in.

Another object of this invention is to read the license plate number on a vehicle while the consumer is in the vehicle in a line for ordering food, and to link one or more vehicle license plates to a loyalty card, CID, so that purchases of the consumer can be stored in association with the consumer CID.

It is another object of this invention to provide an integrated printer that can communicate using two network protocols and communicate to each of two separate computers using one protocol for each of those computers.

Another object of this invention is to provide a line connecting POS terminal to POS computer that does not have a voltage divider so there is no impedance on the line.

Objects of this invention include issuing incentives, promotions, messages, research invitations and game pieces based on pressing certain virtual or mechanical keys in an environment where the location of the keys and/or the products associated with the keys are in a constant state of flux.

These and other objects of the invention are provided by a novel computer network system including at least one POS M central computer having a local store information database, an incentive central computer associated with a purchase data database and a criteria data database, at least one incentive local computer, a lookup table database, a purchase data database, and a criteria data database. Preferably, the system also includes at least one printer and a POS computer having a POS terminal.

The novel computer system enables incentives, promotions, messages, research invitations and game pieces to be issued based on pressing certain virtual or mechanical keys on a POS terminal where such keys correspond to products, totals, subtotals and other functions normally associated with a POS keyboard.

The novel computer system also enables incentives, promotions, messages, research invitations and game pieces to be issued based on pressing certain virtual or mechanical keys on a POS terminal where such keys are specially created to designate demographic characteristics such as male or female, teen or adult, etc.

In one aspect, the invention provides a computer network implemented method, comprising the steps of: transmitting a lookup table in association with a store identification from a POS central computer to an incentive central computer; transmitting said lookup table from said incentive central computer to an incentive local computer for a store associated with said store identification; and converting in said local incentive computer POS terminal data signals propagating on a sniffer line to product codes based at least in -part on said lookup table stored in said local incentive computer.

In another aspect, the invention provides a computer network implemented system comprising: A computer network system comprising: a POS central computer; an incentive central computer; a POS terminal for receiving data from an image touch screen; means for transmitting a lookup table in association with a store identification from said POS central computer to said incentive central computer; an incentive local computer; and means for transmitting said lookup table from said incentive central computer to said incentive local computer for a store associated with said store identification.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic overview of system 1;

FIG. 2 is a schematic view of computer system M1;

FIG. 3 shows a physical plan view schematic of the stations and sensors to scan license plate numbers as a consumer identification;

FIG. 4 is an exemplary database schema showing database tables and table relationships for lookup table database 220, purchase data database 225, and criteria data database 230;

FIG. 5 is a representation of lookup table record 221 in lookup table database 220;

FIG. 6 is a representation of a purchase data record 226 in purchase data database 225;

FIG. 7 is a representation of a criteria data record 231 in criteria data database 230;

FIG. 8 is a representation of a local store information record 81 of local store information database 80;

FIG. 9 is a schematic overview of the method for system 1;

FIG. 10 is a flowchart showing the method for using system 1;

FIGS. 11A and 11B show the electrical configuration for the integrated printer of this invention.

### DETAILED DESCRIPTION OF THE INVENTION

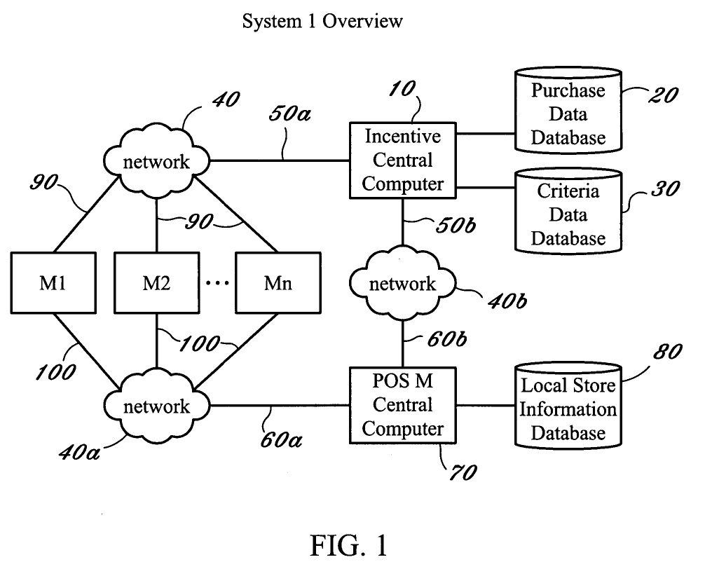

FIG. 1 shows an overview of the novel system 1. The system 1 includes an incentive central computer 10, a central computer purchase data database 20, a central computer criteria data database 30, a network 40, such as the Internet, a connection 50a from the central computer 10 to the network 40, a connection 50b from incentive central computer 10 to network 40b, POS M central computer 70, local store information database 80, a connection 60a from the POS central computer 70 to the network 40a, a connection 60b from the POS M central computer 70 to the network 40b, connections 90 between the network 40 and a plurality of restaurant store computer systems M1, M2, . . . Mn, and connections 100 between the network 40a and a plurality of restaurant store computer systems M1, M2, . . . Mn.

Each of the computer systems M1, M2, . . . Mn include at least one digital computer including associated central processor, memory, input, and output devices.

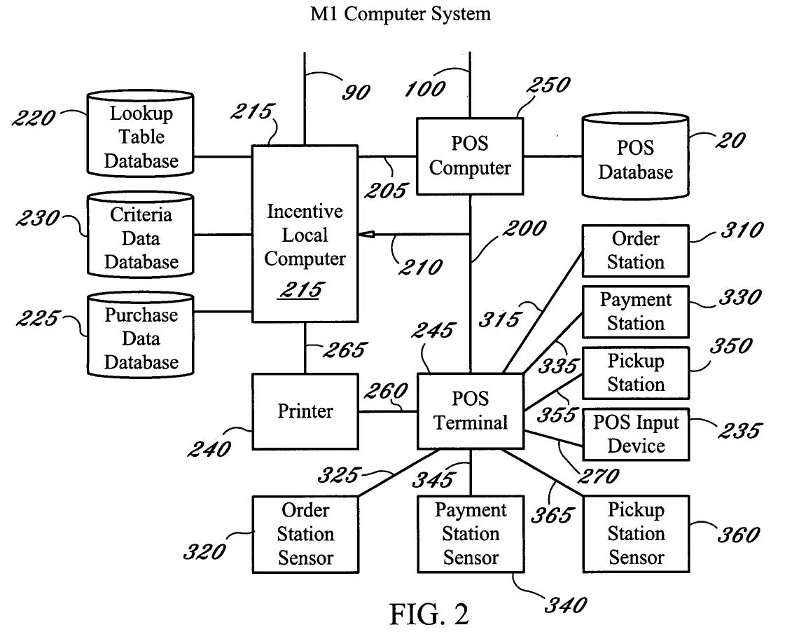

Each restaurant store computer system has structure similar to computer system M1. Computer system M1 includes a physical structure as indicated in FIG. 2. Computer system M1 represents, for example, a POS computer system for managing sales, inventory, and accounting data for a McDonald's brand fast food restaurant. An example of the computer system M1 is shown in FIG. 2 and described in more detail below.

Incentive central computer 10 is connected to incentive local computer 215 via network 40 and is also connected to POS M central computer 70 via network 40b. Incentive central computer 10 is associated with a central computer purchase data database 20 and a central criteria data database 30. Incentive central computer 10 also functions to transfer lookup table database 220 to the incentive local computer 215. Incentive central computer 10 is a computer which is preferably owned by a legal entity, herein referred to as the marketing company.

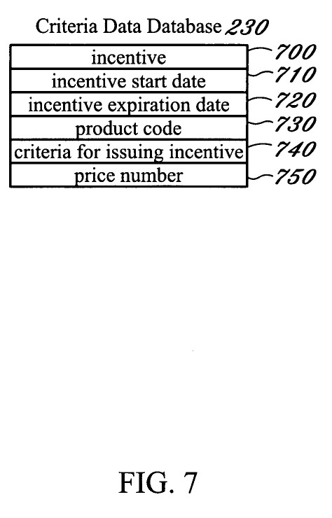

Incentive central computer 10 preferably functions to determine the conditions under which to offer an incentive to a consumer; and transmits criteria for issuing incentives data to incentive local computer 215 so that it will thereafter recognize such conditions and in turn, offer an incentive to the consumer. The criteria for issuing incentives data is stored in a database table. For example, the criteria for issuing incentives could be stored in a record like the record shown in FIG. 7.

Central computer 10 may also store purchase data in association with customer identify data and run criteria against that data in a manner similar to that described for local computer 215. Incentive central computer 10 may identify criteria for issuing incentives, and periodically transmit that criteria for issuing incentives back to local computer 215 for storage in criteria data database 230. Alternatively, incentive central computer 10 may retain the criteria for issuing incentives, and monitor, via local computer 215, identifications in the computer system M1 data stream and respond with criteria for issuing incentives when noting an identification for which there exists a stored action. Incentive central computer 10 can also transmit to specified ones or all of computer systems M1, M2 . . . Mn criteria for issuing incentives for storage in the criteria data database 230 at each store. Incentive central computer 10 may act in real time.

Purchase data database 20 refers to the database that is controlled by incentive central computer 10. Purchase data database 20 preferably stores transaction identification field, lane number field, consumer identification field, number of items purchased field, price number field, product code field, product description field, product purchase price field, date of transaction field, time of transaction field, time at order station field, time at payment station field, and time at pickup station field.

Criteria data database 30 refers to the database that is controlled by incentive central computer 10. Criteria data database 30 preferably stores an incentive field, an incentive start date field, an incentive expiration date field, a product code field, criteria for issuing incentive, and a price number.

Network 40 refers to a network system, for example a dial up, private digital corporate network, or the Internet. Network 40 may be the same or different from networks 40a and 40b. The incentive central computer 10 communicates to the incentive local computer 215 via network 40.

Network 40a refers to a network system, including a dial up, private digital corporate network, or the Internet. Network 40a may be the same or different from networks 40 and 40b. The POS M central computer 70 communicates to the POS computer 250 via network 40a.

Network 40b refers to a network system, including a dial up, private digital corporate network, or the Internet. Network 40b may be the same or different from Networks 40 and 40a. The incentive central computer 10 communicates to the POS M central computer 70 via network 40b.

Connection 50a refers to the line connecting incentive central computer 10 to network 40.

Connection 50b refers to the line connecting incentive central computer 10 to network 40b.

Connection 60a refers to the line connecting POS M central computer 70 to network 40a.

Connection 60b refers to the line connecting POS M central computer 70 to the network 40b.

POS M central computer 70 refers to the central computer for computer systems M1, M2, . . . Mn. POS M central computer 70 generates and stores product codes for the products sold in computer systems M1, M2, . . . Mn. POS M central computer is connected to POS computer 250 via network 40a. POS M central computer uploads POS terminal data signals from computer system M1 and stores them in association with the store identification for computer system M1. POS M central computer 70 is also associated with local store information database 80.

Local store information database 80 refers to the database that is controlled by POS M central computer 70. The local store information database 80 may store the correspondence between POS terminal data signals and product items, currently in use in each, or at least a large number of, McDonald's brand restaurants, for computer systems M1, M2, . . . Mn. Specifically, the local store information database 80 stores a store identification and POS terminal data signals associated with that store identification. POS terminal data signals contain the information in the lookup table, which includes a product code, a description of product, the prices of the product, and a sequence of keys pressed.

Connection 90 refers to the line connecting the network 40 and a plurality of restaurant store computer systems M1, M2, . . . Mn.

Connection 100 refers to the line connecting the network 40a and a plurality of restaurant store computer systems M1, M2, . . . Mn.

FIG. 2 shows computer system M1. Computer system M1 includes an incentive central computer 10, purchase data database 20, criteria data database 30, a network 40, a network 40b, a POS M central computer 70, a local store information database 80, a network 40a, a connection 200 connecting POS computer 250 to POS terminal 245, a connection 205 connecting POS computer 250 to incentive local computer 215, an incentive local computer 215, a lookup table database 220, a purchase data database 225, a criteria data database 230, a POS input device 235, a connection 270 connecting POS input device 235 to POS terminal 245, a printer 240, a POS terminal 245, a POS computer 250, a POS database 255, a connection 100 connecting POS computer 250 to network 40a, a connection 260 connecting POS terminal 245 to printer 240, a connection 265 connecting incentive local computer 215 to printer 240, order station sensor 320, a connection 325 connecting order station sensor 320 to POS terminal 245, payment station sensor 340, a connection 345 connecting payment station sensor 340 to POS terminal 245, pickup station sensor 360, a connection 365 connecting pickup station sensor 360 to POS terminal 245, order station 310, a connection 315 connecting order station 310 to POS terminal 245, payment station 330, a connection 335 connecting payment station 330 to POS terminal 245, a pickup station 350, and a connection 355 connecting pickup station 350 to POS terminal 245.

Connection 200 is the line connecting the POS terminal 245 to the POS computer 250. The line 200 typically transmits information encoded as digital signals, such as a temporally spaced sequence of voltage pulses at two distinct voltages, such as 0 volts and 5 volts, or five volts and ten volts. The line 200 may vary from each retail store. Furthermore, the line 200 does not have a voltage divider so there is no impedance on the line. In one embodiment, there is a line parallel to line 200, for reading a consumer's license plate.

Connection 205 is the direct data line between the incentive local computer 215 and the POS computer 250.

Sniffer line 210 is a line that connects to or otherwise detects the digital data stream, or the POS terminal data signal, being transmitted from the POS terminal 245 to the POS computer 250. The sniffer line 210 carries the POS terminal data signal to an input of local computer 215.

Incentive local computer 215 is a computer connected to incentive central computer 10 via network 40. Incentive local computer 215 sits in computer systems M1, M2, . . . Mn. Incentive local computer 215 converts the POS terminal data signals to actual product codes based on lookup tables received. Incentive local computer 215 preferably uploads purchase data with associated consumer identification, analyzes that data and generates incentives.

Lookup table database 220 is the database that is controlled by incentive local computer 215. Lookup table database 220 stores the product code, description of product, price1 of product, price 2 of product, price 3 of product, price 4 of product, price 5 of product, price 6 of product, and sequence of keys pressed.

Purchase data database 225 is the database that is controlled by incentive local computer 215. Purchase data database 225 may store purchase information received and sniffed, from the data line 200 by the sniffer line 210. This data may be analyzed “in real time”, which means that during a customer's transaction at the POS terminal the transaction data is analyzed to determine if the local computer should generate an incentive to the consumer. Purchase data database 225 preferably stores transaction ID, lane number, consumer identification, number of items purchased, price number, product code, product description, product purchase price, date of transaction, time of transaction, time at order station, time at payment station, and time a pickup station.

Criteria data database 230 is the database that is controlled by incentive local computer 215. Criteria data database 230 preferably stores incentive, incentive start date, incentive expiration date, product code, criteria for issuing incentive, and price number. Criteria data database 230 stores criteria against which the purchase data received from POS terminal 245 may be run. When criteria are met, local computer 215 takes certain action. Specifically, local computer 215 may store this data, or it may immediately send an incentive to printer 240. Alternatively, incentive local computer 215 may send an electronic message, or instruction, to POS computer 250 and/or POS terminal 245. The electronic message may be, for example, an instruction to offer to the customer at the POS terminal an incentive, such as a coupon, a notification, the existence of a charity event, or a game that the consumer may participate in, or instruct the teller at the POS terminal to give the consumer a specific sample or free product. Alternatively, the criteria for issuing an incentive in association with a CID may be stored in criteria data database 230. The incentive local computer 215 can then forego giving incentives, notifications, and free products in real time, and activate the stored criteria for issuing incentives upon subsequent identification of the stored CID in the datastream read from sniffer line 210.

POS input device 235 is a device whereby a consumer identification may be entered. POS input device 235 is attached to POS terminal 245 via line 270. Examples of POS input devices include-a bar code reader, a magnetic card reader, keypad input, or a sensor to scan a license plate. Additionally, order station sensor 320, payment station sensor 340, and pickup station sensor 360 are types of POS input devices.

Printer 240 is a printer that sits in computer systems M1, M2, . . . Mn. Incentives offered by marketing company are printed on printer 240. Printer 240 is an integrated printer, and can communicate to two network protocols, a parallel protocol and an Ethernet. Printer 240 is connected POS terminal 245 and incentive local computer 215.

POS terminal 245 is the terminal where transaction data is entered. A POS terminal preferably is associated with an image touch screen having icons that relate to products. POS terminal 245 is connected to POS computer 250 via line 200. Order station 310, payment station 330, and a printer at pickup station 350 are connected to POS terminal 245. In addition, order station sensor 320, payment station sensor 340, and pickup station sensor 360 are connected to POS terminal 245. Also, POS input device 235 is connected to POS terminal 245.

POS computer 250 is the POS computer that controls the inventory and accounting functions of computer systems M1, M2, . . . Mn. POS computer 250 is connected to POS M central computer via network 40a. POS computer 250 is associated with POS database 255. POS computer 250 is connected to POS terminal via line 200.

POS database 255 is the database that is controlled by POS computer 250. POS database 255 refers to a database for storing a POS terminal data signal to product identifications and optionally price lookup tables, inventory, etc. Preferably, POS database 255 is a file that preferably includes records containing information for managing points accounts of consumers in accordance with the present invention. The records in the POS database 255 preferably contain fields for associating consumers with account IDs, coupon values, transaction dates, and coupon points. The POS database 255 also preferably includes operations for searching, sorting, recombining, and other database functions. The POS database 255 may be implemented as two or more databases, if desired. Preferably, sales transaction information stored in the POS database 255 is periodically (e.g., daily or weekly) retrieved by the incentive local computer 215 and sent to the incentive central computer 10, which uses the information to update the points accounts of consumers stored in the purchase data database 225 and purchase data database 20.

Connection 270 is the line connecting POS input device 235 to POS terminal 245.

Order station sensor 320 is a sensor that reads the consumer vehicle's license plate while the consumer's vehicle is at the order station 310. The order station sensor 320 sends the time and data that the consumer's vehicle is at the order station 310 to the POS terminal 245 via line 325. The incentive local computer 215 then uploads this information in one of two ways. First, the POS terminal 245 sends the time and date to the POS computer 250 via line 200. The POS computer 250 sends a message to the incentive local computer 215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection line 325 is the line connecting order station sensor 320 to POS terminal 245.

Payment station sensor 340 is a sensor that reads the consumer vehicle's license plate while the consumer's vehicle is at the payment station 330. The payment station sensor 340 sends the time and date that the consumer's vehicle is at the payment station 330 to the POS terminal 245 via line 345. The incentive local computer 215 then uploads this information in one of two ways. First, the POS terminal 245 sends the time and date to the POS computer 250 via line 200. The POS computer 250 then sends a message to the incentive local computer 215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection line 345 is the line connecting payment station sensor 340 to POS terminal 245.

Pickup station sensor 360 is a sensor that reads the consumer vehicle's license plate while the consumer's vehicle is at the pickup station 350. The pickup station sensor 360 sends the time and date that the consumer's vehicle is at the pickup station 350 to the POS terminal 245 via line 365. The incentive local computer 215 then uploads this information in one of two ways. First, the POS terminal 245 sends the time and date to the POS computer 250 via line 200. The POS computer 250 then sends a message to the incentive local computer 215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection line 365 is the line connecting pickup station sensor 360 with the POS terminal 245.

Order station 310 is the station connected POS terminal 245 in computer systems M1, M2, . . . Mn where orders are placed from a consumer vehicle. Preferably, order station 310 is connected to POS terminal 245 via line 315.

Connection line 315 is the line that connects order station 310 with POS terminal 245.

Payment station 330 is the station connected to POS terminal 245 in computer systems M1, M2, . . . Mn where the consumer pays for the products that were ordered at the order station 310. Preferably, payment station 330 is connected to POS terminal 245 via line 335.

Connection line 335 is the line that connects payment station 330 with POS terminal 245.

Pickup station 350 is the station where the consumer picks up the products they ordered and paid for. Preferably, there is a printer at pickup station which is connected to computer systems M1, M2, . . . Mn so that incentives can be given to the consumer at the pickup station. Preferably, the printer at pickup station 350 is connected to POS terminal 245 via line 355.

Connection line 355 is the line that connects the printer in pickup station 350 with POS terminal 245.

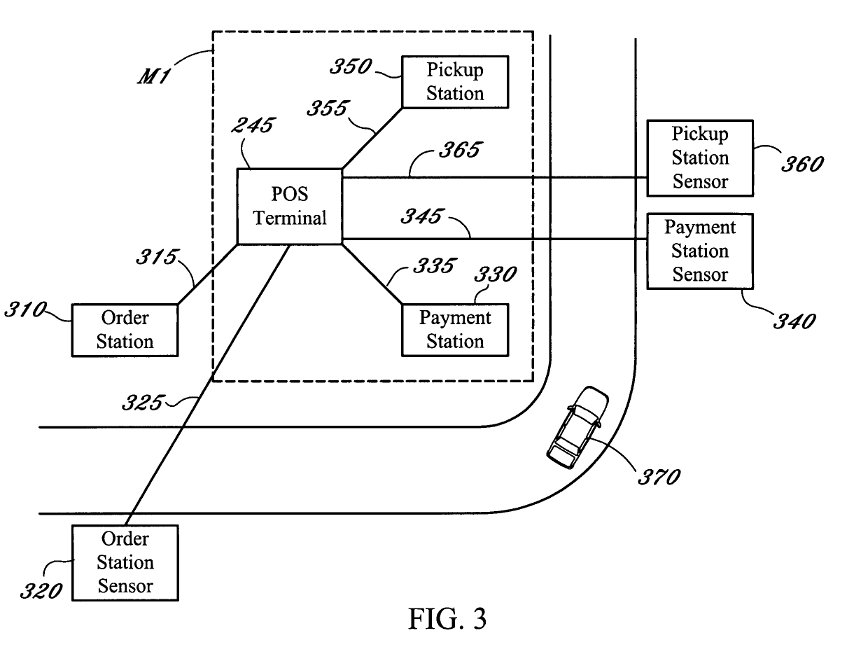

The system in FIG. 3 includes a M restaurant 300, an order station 310, a connection 315 connecting order station 310 to POS terminal 245, an order station sensor 320, a connection 325 connecting order station sensor 320 to POS terminal 245, a payment station 330, a connection 335 connecting payment station 330 to POS terminal 245, a payment station sensor 340, a connection 345 connecting payment station sensor 340 to POS terminal 245, a pickup station 350, a connection 355 connecting pickup station 350 to POS terminal 245, a pickup station sensor 360, a connection 365 connecting pickup station sensor 360 to POS terminal 245, and a customer vehicle 370.

M restaurant 300 represents a quick service restaurant, such as a McDonalds brand retail store.

Order station 310 is the terminal where orders are placed from a consumer vehicle. Order station 310 is connected to POS terminal 245 via line 315.

Connection 315 is the line connecting order station 310 to POS terminal 245.

Order station sensor 320 is a sensor that reads the consumer vehicle's license plate while the consumer's vehicle is at the order station 310. The order station sensor 320 sends the time and date that the consumer's vehicle is at the order station 310 to the POS terminal 245 via line 325. The incentive local computer 215 then uploads this information in one of two ways. First, the POS terminal 245 sends the time and date to the POS computer 250 via line 200. The POS computer 250 then sends a message to the incentive local computer 215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection 325 is the line connecting order station sensor 320 with POS terminal 245.

Payment station 330 stores the station where the consumer pays for the products that were ordered at order station 310. Payment station 330 is connected to POS terminal 245 via line 335.

Connection 335 is the line connected payment station 330 with POS terminal 245.

Payment station sensor 340 is a sensor that reads the consumer vehicle's license plate while the consumer's vehicle is at the payment station 330. The payment station sensor 340 sends the time and date that the consumer's vehicle is at the payment station 330 to the POS terminal 245 via line 345. The incentive local computer 215 then uploads this information in one of two ways. First, the POS terminal 245 sends the time and date to the POS computer 250 via line 200. The POS computer 250 then sends a message to the incentive local computer-215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection 345 is the line connecting payment station sensor 340 with POS terminal 245.

Pickup station 350 is the station of the M restaurant where consumers pick up the products they ordered and paid for. Preferably, pickup station 350 has a printer which is connected to POS terminal 245 via line 355.

Connection 355 is the line connecting the printer of pickup station 350 to POS terminal 245.

Pickup station sensor 360 is a sensor that reads the consumer vehicle's license plate while the consumer's vehicle is at the pickup station 350. The pickup station sensor 360 sends the time and date that the consumer's vehicle is at the pickup station 350 to the POS terminal 245 via line 365. The incentive local computer 215 then uploads this information in one of two ways. First, the POS terminal 245 sends the time and date to the POS computer 250 via line 200. The POS computer 250 then sends a message to the incentive local computer 215 that an event has occurred. Criteria is set up in the POS computer 250 for when messages should be send and what information that message should contain. Second, the incentive local computer 215 gets the time and date information via sniffer line 210. Incentive local computer 215 then stores the time the consumer is at the order station 310 in purchase data database 225.

Connection 365 is the line connecting pickup station sensor 360 with POS terminal 245.

Customer vehicle 370 is the vehicle the consumer uses to drive through the drive thru of M restaurant 300 to each of the order station 310, the payment station 330, and the pickup station 360. The consumer vehicle preferably has a license plate.

In one embodiment, an incentive is issued depending on the service in the drive-thru line. For example, if the service takes more time than a specified interval, the consumer will be issued an incentive at the pickup station 350. The retail store determines the level of service desired and thus predetermines a specified interval. Examples of specified intervals include 30 seconds, 1 minute, 2 minutes, 3 minutes, 4 minutes, 5 minutes, etc. For example, if it takes more than one minute for the consumer to get from the order station 310 to the pickup station 350, an incentive will issue to that consumer. The incentive can be a generic incentive, or an incentive based on how frequently the consumer purchases products at the retail store. For example, if it is determined that the consumer frequently purchases products at the retail store, and the consumer is in line for longer than the specified interval, the consumers may be issued an incentive for a free meal. Alternatively, the consumer can be issued an incentive at the payment station 330 based on service in the drive-thru line.

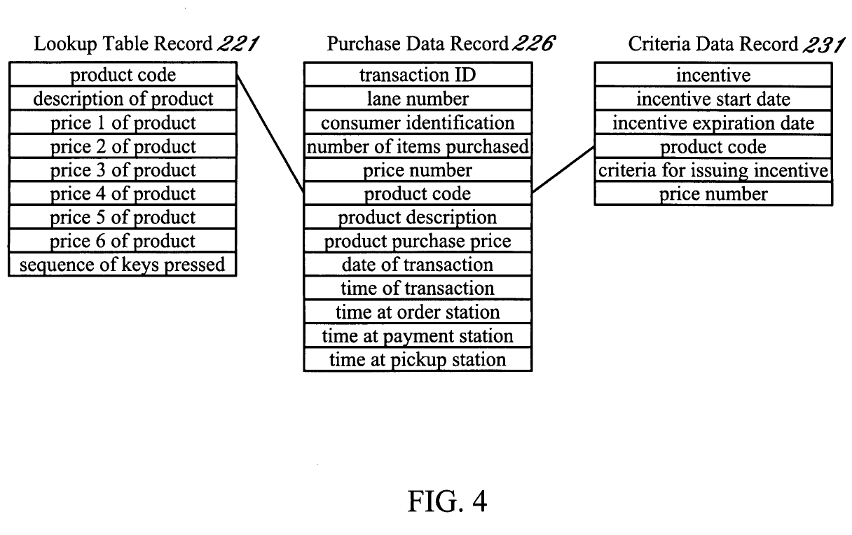

FIG. 4 is a exemplary database schema showing database tables and table relationships. This relational database stores data in the form of related tables. Each table contains one or more data categories in columns. Each row contains unique data for the categories in each column. FIG. 4 shows a sample record for three tables of this relational database: Lookup table record 221, purchase data record 226 and criteria data record 231. Each record shows an example of the type of data that is stored in the table. Each table is linked to the others by the product code field.

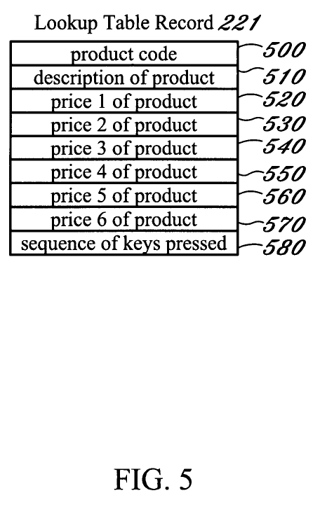

FIG. 5 shows a representation of a lookup table record 221. Lookup table record 221 represents data for a lookup table that is used to convert the POS terminal data signals from the POS terminal 245 to meaningful information. It shows field names for fields of record 221. Each field stores corresponding data. Each lookup table record in lookup table database generally contains data for the field names shown in lookup table record 221. Preferably, a lookup table database is stored on incentive local computer 215.

Lookup table record 221 preferably includes product code 500, description of product 510, price 1 of product 520, price 2 of product 530, price 3 of product 540, price 4 of product 550, price 5 of product 560, price 6 of product 570, and sequence of keys pressed 580.

Produce code field 500 stores a product code.

Description of product field 510 stores information describing the products sold at M retail store. For example, this field would store whether the product was a hamburger and preferably stores the specific type of hamburger, such as Big Mac. It could also store that the product was french fries, and preferably stores the size of fries. The field would also store the type and size of beverage.

Price 1 of product field 520 stores the price of a product purchased by a non-employee.

Price 2 of product field 530 stores the price of a product purchased by an employee.

Price 3 of product field 540 stores the price of a product purchased by a manager.

Price 4 of product field 550 stores an additional price as designated by the retail store.

Price 5 of product field 560 stores an additional price as designated by the retail store.

Price 6 of product field 570 stores an additional price as designated by the retail store.

Sequence of keys pressed field 580 stores the sequence of the keys pressed at the POS terminal 245. For example, if a consumer buys a hamburger at lunch time, the sequence of keys field would store the information that a product was purchased from menu 3, brought up by key 7. There is only one key sequence per product. Each key sequence preferably has 6 price fields associated with it. The type of discount tells which price to charge. The key sequence data signal is typically a binary data format signal.

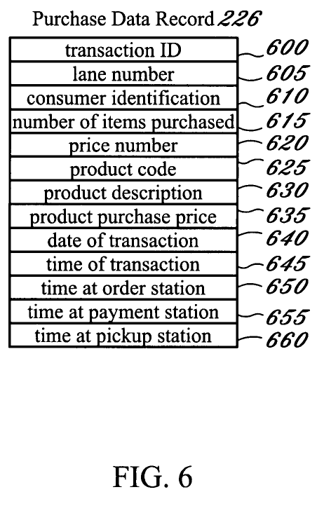

FIG. 6 shows a representation of purchase data record 226 contained in purchase data database 225. Purchase data record 226 represents data for a transaction. It shows record field names for fields of record 226. Each field stores corresponding data. Each purchase data record in purchase data database 225 generally contains the fields identified in purchase data record 226, although in different structures. Preferably, both incentive local central computer 10 and local incentive computer 215 are associated with a purchase data database. Preferably, incentive local central computer is associated with purchase data database 20 and local incentive computer 215 is associated with purchase data database 225.

Purchase data record 226 preferably includes transaction ID 600, lane number 605, consumer identification 610, number of items purchased 615, price number 620, product code 625, product description 630, product purchase price 635, date of transaction 640, time of transaction 645, time at order station 650, time at payment station 655, time a pickup station 660.

Transaction ID field 600 stores a unique identification associated with a transaction.

Lane number field 605 stores the lane number associated with the POS terminal 245 where the transaction occurs.

Consumer identification field 610 stores a CID.

Number of items purchased field 615 stores the number of items purchased in one transaction. For example if two hamburgers were purchased, the number two would be stored in this field.

Price number field 620 stores a numerical value of 1, 2, 3, 4, 5, or 6. Number 1 represents a regular purchase. Number 2 represents an employee purchase. Number 3 represents a manager purchase. Number 4 represents an additional price field as designated by the retail store. Number 5 represents an additional price field as designated by the retail store. Number 6 represents an additional price field as designated by the retail store.

Product code field 625 stores a product code.

Product description field 630 stores information describing the products sold at M retail store. For example, this field would store whether the product was a hamburger and preferably stores the specific type of hamburger, such as Big Mac. It could also store that the product was french fries, ad preferably stores the size of fries. The field would also store the type and size of beverage.

Product purchase price field 635 stores the price of the product purchased in the transaction.

Date of transaction field 640 stores the date of the transaction data for which is stored in purchase data record 225.

Time of transaction field 645 stores the time of the transaction data which is stored in purchase data record 226.

Time at order station field 650 stores the time of the transaction at the order station 310.

Time at payment station field 655 stores the time of the transaction at the payment station 330.

Time at pickup station field 660 stores the time of the transaction at the pickup station 350.

Product purchase record 226 is exemplary only, since many different formats may be used to store POS data associated with a consumer. For example, data may be reorganized and stored by product code instead of transaction ID.

FIG. 7 shows a representation of a record in the criteria data record 231 from criteria data database 230. Criteria data record 231 represents data for criteria in determining whether to offer an incentive. It shows field names for fields of record 231. Each field stores corresponding data. Each criteria data record in criteria data database generally contains data for the field names shown in criteria data record 231. Preferably, a criteria data database is associated with incentive local computer 215 and incentive central computer 10. Preferably incentive local computer 215 is associated with criteria data database 230 and incentive central computer 10 is associated with criteria data database 30.

Criteria data record preferably includes incentive 700, incentive start date 710, incentive expiration date 720, product code 730, criteria for issuing incentive 740, and price number 750.

Incentive field 700 stores value offered to a consumer the receipt of which by the consumer is contingent upon the consumer entering into a specified transaction.

Incentive start date 710 stores the date in which the incentive will be first offered.

Incentive expiration date field 720 stores the date in which the incentive becomes invalid.

Product code field 730 stores a product code.

Criteria for issuing incentive 740 field stores the data for criteria for issuing an incentive. There are many different types of criteria for issuing incentives. Examples of criteria includes time to fill order, license plate, product code, time of day, type of line, history of purchases, consumer identification, demographics, etc. For example, an incentive may issue depending on whether the consumer is walking up or driving thru. Additional criteria includes the number of products purchased, for example, there may be an incentive that requires the customer to purchase 2 hamburgers. Another type of criteria would be price number; for example, an incentives may be issued only to regular customers (price number 1). Incentives may be issued depending on incentive type. For example, the incentive type might by buy 1 unlimited, and if the customer buys 5 he gets five incentives. Or the incentive could be buy 1 limited, so if the customer buys 5 in a transaction he gets only one incentive. Other incentive criteria includes the type of consumer identification, for example, whether the consumer uses a MasterCard, Visa, or loyalty card. An incentive may be issued if the order price was greater than $10 and the customer purchased chicken nuggets. Essentially, the incentive type could be anything that a creative marketer could come up with.

Price number field 750 stores a numerical value of 1, 2, 3, 4, 5, or 6. Number 1 represents a regular purchase. Number 2 represents an employee purchase. Number 3 represents a manager purchase. Number 4 represents an additional price field as designated by the retail store. Number 5 represents an additional price field as designated by the retail store. Number 6 represents an additional price field as designated by the retail store.

Criteria data record 231 is exemplary only, since many different formats may be used to store criteria data. For example, data may be reorganized and stored by incentive instead of by product code.

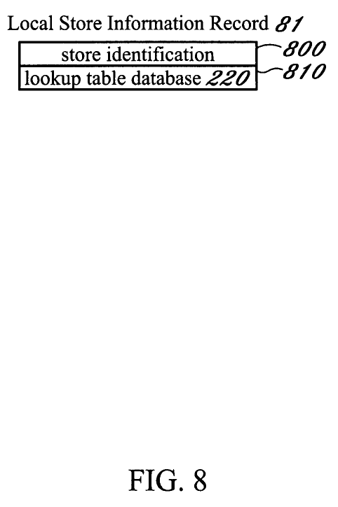

FIG. 8 shows a representation of a record from local store information record 81 from local store information database 80. Local store information record 81 represents data associated with a local store identification and its corresponding POS terminal data signals. It shows field names for fields of record 81. Each field stores corresponding data. Each local store information record in local store information database generally contains data for the field names shown in local store information database record 81. Preferably, a local store identification database is associated with POS M central computer 70.

Local store information record 81 preferably includes store identification 800 and POS terminal data signals 810.

Store identification field 800 stores an identification associated with computer systems M1, M2, . . . Mn.

Lookup table database 220 field 810 stores the lookup table information as determined by POS computer 250. The lookup table database 220 field 810 stores the same information as the Lookup table record 221 stores. Thus, the lookup table database 220 field 810 stores product code, description of product, price 1 of product, price 2 of product, price 3 of product, price 4 of product, price 5 of product, price 6 of product, and sequence of keys pressed.

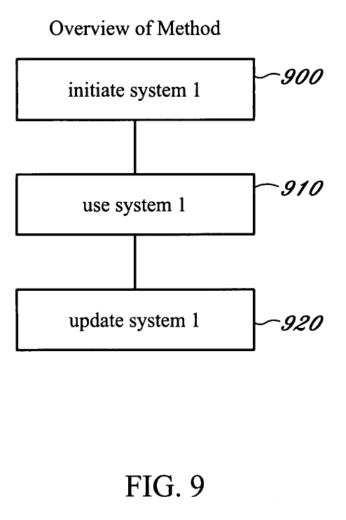

FIG. 9 shows a method overview of the present invention. In step 900, the system 1 is initiated, in step 910 system 1 is used, and in step 920 system 1 is updated.

In step 900, system 1 is initiated. During the initiation step, the networks are set up, the databases are set up, and the computer systems are connected to each other and to the networks.

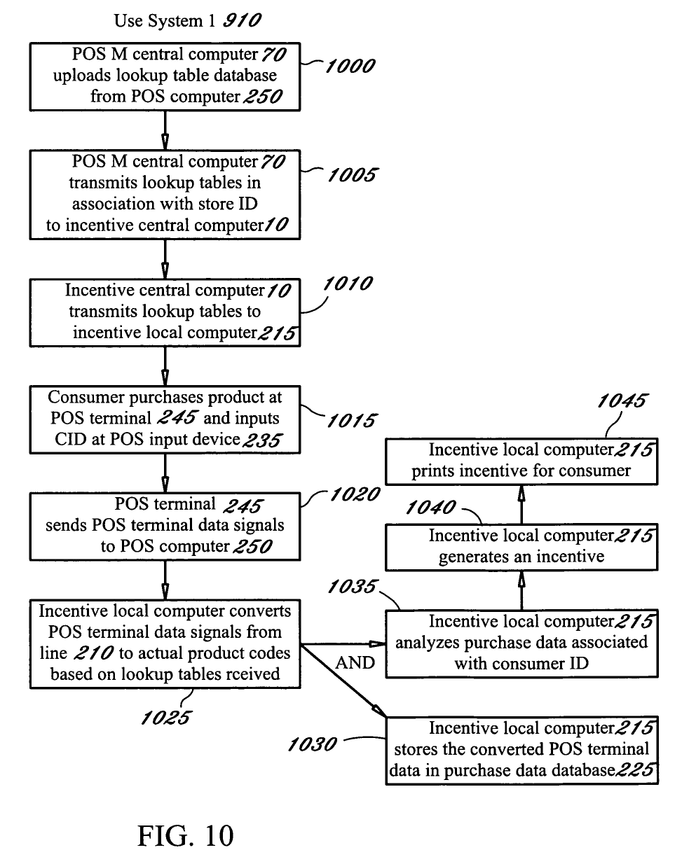

In step 910, system 1 is used. FIG. 10 shows the use of system 1.

In step 920, system 1 is updated. The system is updated when the POS M central computer uploads new lookup table information from the POS computer 250. There are two ways in which updates can be made to system 1 and the time it takes to implement the changes depends on the type of communication vehicle used. First, the tables from the POS computer 250 can be pulled up nightly, which can cause up at a 48 delay. Second, system 1 can check on an hourly basis for new updates via the Internet.

FIG. 10 is a flowchart showing the method for using system 1.

In step 1000, POS M central computer 70 uploads lookup table database from POS computer 250.

In step 1005, POS M central computer 70 transmits lookup tables in association with store identification to incentive central computer 10 via network 40b. Optionally, the incentive central computer 10 runs code that revises the lookup table file formats to a standardized file format.

In step 1010, incentive central computer 10 transmits lookup tables to incentive local computer 215 via network 40.

In step 1015, consumer purchases product at POS terminal 245 and inputs CID at POS input device 235.

Alternatively, a consumer's license plate number may be scanned at order station sensor 320, payment station sensor 340 or pickup station 360 and used as the consumer ID.

In step 1020, POS terminal 245 sends POS terminal data signals to POS computer 250 via line 200.

In step 1025, incentive local computer 215 converts POS terminal data signals from line 210 to actual product codes based on lookup tables received.

The POS terminal data signals contain the following purchase data: transaction ID, or order ID, lane number, consumer ID, sequence of keys for purchase, number of items in purchase data, price number. Transaction ID, also known as order ID, is a unique number identifying the particular transaction. Lane number is the lane number in which the transaction occurs. Lane number is necessary so that the incentive can get delivered to the correct lane. Sequence of keys for the purchase is the sequence of keys pressed at the POS terminal to purchase the product. Number of items in purchase data is the number of items the consumer purchased in one transaction. For example, if a person bought two hamburgers in a single transaction, the number of items in purchase data would indicate two. Price number stores a numerical value of 1, 2, 3, 4, 5, or 6. Number 1 represents a regular purchase. Number 2 represents an employee purchase. Number 3 represents a manager purchase. Number 4 represents an additional price field as designated by the retail store. Number 5 represents an additional price field as designated by the retail store. Number 6 represents an additional price field as designated by the retail store.

The sequence of keys is used to look up the product code, product description and price paid from the lookup table record 221. The date and times from the various POS terminals are date stamped in the purchase data. Some of the purchase transactions could be unrelated items. For example, the total amount when the sales person presses the total key or the end of transaction after the person tenders the cash and completes the transaction. The same sequence can represent different transactions, for instance, the same sequence can represent purchases by walk up, drive thru, and garden. The transaction can be flagged at the beginning or end of the transaction. There is one table for flags, and one table for key sequences depending on the flags. These are not normalized, there are fixed prices.

At this point, the item purchase data contains the following information: transaction ID, lane number, consumer ID, sequence of keys pressed for purchase (no longer relevant now that a specific product code is known), number or items in purchase data, price number, product code, product description, item price. This data, except for sequence of keys, is then stored in the purchase data database 225. The transaction data is reviewed each time an additional item purchase is added. The criteria data table 230 is then scanned for a product code that is purchased.

After step 1025, system 1 performs steps 1030 and 1035.

In step 1030, incentive local computer 215 stores the converted POS data and stores the data in purchase data database 225.

In step 1035, incentive local computer 215 analyzes purchase data associated with consumer identification. Incentive local computer 215 reviews the purchase data from the transaction and scans criteria for issuing incentives to determine if it should offer an incentive.

In step 1040, incentive local computer 215 generates an incentive. Incentives may be generated if certain criteria is met. Alternatively, an incentive may be generated if a key that designates demographic characteristics such as male or female, teen or adult, etc. was pressed.

In step 1045, incentive local computer 215 prints incentive for consumer.

One very useful procedure of the invention is as follows.

The M central computer optionally transmits an instruction to the computer system M1's POS computer 250 to upload the POS terminal 245 data signal to product correspondence lookup table.

The M central computer repeats the process of uploading the POS terminal data signals for each one of the POS computer systems associated with a plurality of stores, such as computer systems M1, M2 . . . Mn, keeping track of the identity of each store (by logical number or address). The POS terminal data signals may be different for each computer systems M1, M2, . . . Mn.

The POS M central computer transmits the pulled up lookup table files in association with the store identification from which each file originated to the central computer 10.

Optionally, the incentive central computer 10 runs code that revises the lookup table file formats to a standardized file format.

The central computer 10 then transmits the lookup table files to the local computers, like local computer 215, in each one of computer systems M1,M2 . . . Mn, such that each local computer has a lookup table accurate for the retail store from which it is sniffing POS terminal data signals along a line like sniffer line 210.

The foregoing process updates the incentive local computer 215 in each one of the computer systems M1, M2 . . . Mn either hourly or nightly, so that its lookup table's data is the same as the POS terminal data signals in the POS computer 250.

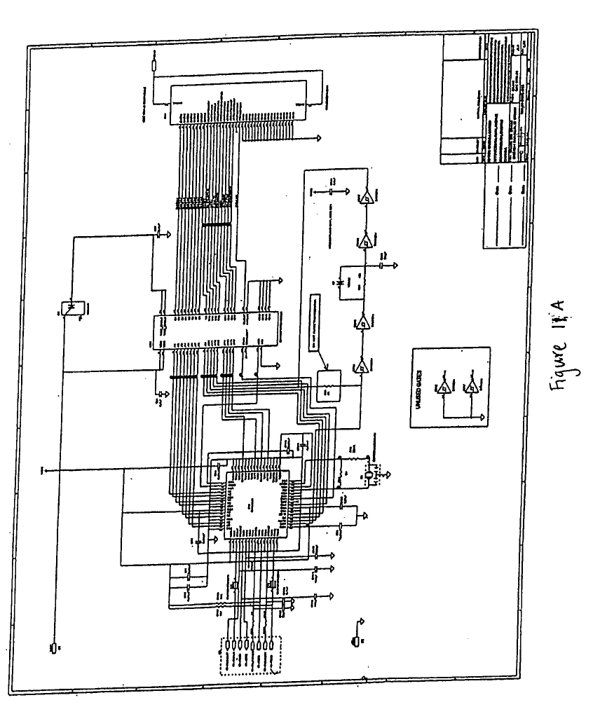

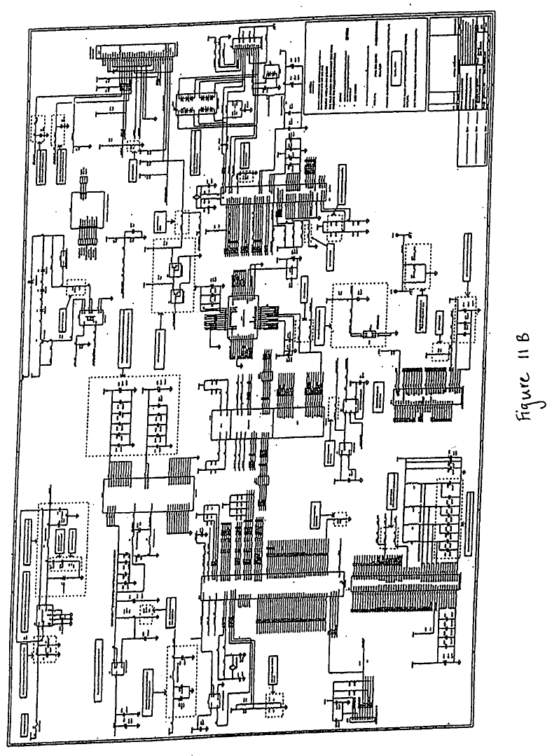

FIGS. 11A and 11B show the electrical configuration of the integrated printer used in this invention. This printer sits in computer systems M1, M2, . . . Mn. Incentives offered by the marketing company are printed on this printer. The printer shown in FIGS. 11A and 11B is an integrated printer, and can communicate to two network protocols, a parallel protocol and Ethernet protocol. The printer shown in FIGS. 11A and 11B is connected to both POS terminal 245 and incentive local computer 215. It can communicate the same or similar information concurrently to both devices using a different data protocol to each device.

1. A computer network implemented method comprising:
transmitting a lookup table in association with a store identification from a POS central computer to an incentive central computer;
transmitting said lookup table from said incentive central computer to an incentive local computer for a store associated with said store identification; and
converting in said local incentive computer POS terminal data signals propagating on a sniffer line to product codes based at least in part on said lookup table stored in said local incentive computer.

2. The method of claim 1, wherein said POS central computer can transmit data to said incentive central computer via a network.

3. The method of claim 2, wherein said network is the Internet.

4. The method of claim 2, wherein said network is a private digital corporate network.

5. The method of claim 2, wherein said network is a dial-up network.

6. The method of claim 2, wherein said transmitting from said POS central computer to said incentive central computer is via said network.

7. The method of claim 1, wherein each record in said lookup table has fields for at least product code, description of product, price 1 of product, and sequence of keys pressed.

8. The method of claim 1, wherein said POS central computer comprises an associated central processor, memory, input, and output devices.

9. The method of claim 1, wherein said POS central computer is associated with a local store information database.

10. The method of claim 1, wherein said incentive central computer comprises an associated central processor, memory, input, and output devices.

11. The method of claim 1, wherein said incentive central computer is associated with a purchase data database configured to store purchase data and a criteria data database configured to store criteria applicable at least to purchase data.

12. The method of claim 1, wherein said incentive central computer is connected to said incentive local computer via a network.

13. The method of claim 12, wherein said transmitting from said incentive central computer to said incentive local computer is via said network.

14. The method of claim 12, wherein said network wherein said network is the Internet.

15. The method of claim 12, wherein said network is a private digital corporate network.

16. The method of claim 12, wherein said network is a dial-up network.

17. The method of claim 1, wherein said incentive local computer comprises an associated central processor, memory, input, and output devices.

18. The method of claim 1, wherein said incentive local computer has a memory storing said lookup table, purchase data database to store purchase data and a criteria data database configured to store criteria applicable at least to purchase data.

19. The method of claim 18, wherein a record in said lookup table database contains at least the fields product code, description of product, price 1 of product, and sequence of keys pressed.

20. The method of claim 18, wherein a record in said purchase data database contains at least the fields consumer identification, product code, product purchase price, and date of transaction.

21. The method of claim 18, wherein a record in said criteria data database contains fields for at least: incentive description, incentive start date, incentive expiration date, product code, criteria for issuing incentive, and price number.

22. The method of claim1, wherein said incentive local computer connects to a printer associated with at least one POS terminal.

23. The method of claim 22, wherein said printer is designed to communicate using at least two network protocols.

24. The method of claim 1, wherein said POS terminal data signals comprise data for transaction ID, lane number, sequence of keys for purchase, number of items in purchase data, and price number.

25. The method of claim 1, wherein said sniffer line is a line that connects to or otherwise detects said POS terminal data signals as a data stream being transmitted from a POS terminal to a POS computer.

26. The method of claim 25, wherein said POS terminal and said POS computer are connected by a POS terminal line that does not connect to a voltage divider so that there is minimal impedance on said POS terminal line.

27. The method of claim 25, wherein said sniffer line propagates said digital signal to an input of said incentive local computer.

28. The method of claim 1, wherein said product codes are defined by a corporation.

29. The method of claim 1, wherein said POS terminal data signals originate from a POS terminal.

30. The method of claim 29, wherein said POS terminal includes an image touch screen.

31. The method of claim 29, wherein said POS terminal connects to at least one of an order station sensor, a payment sensor, a pickup station sensor, a POS input device, an order station, a payment station, and a printer associated with a pickup station.

32. The method of claim 25, wherein said POS computer is associated with a POS database configured to store data received in at least one POS terminal.

33. The method of claim 25, wherein said POS computer comprises an associated central processor, memory, input, and output devices.

34. The method of claim 25, wherein said POS computer is connected to POS central computer via a network.

35. The method of claim 34, wherein said network is the Internet.

36. The method of claim 34, wherein said network is a private digital corporate network.

37. The method of claim 34, wherein said network is a dial-up network.

38. The method of claim 1, further comprising said incentive local computer analyzing said converted POS terminal data signals.

39. The method of claim 38, further comprising said incentive local computer generating an incentive based on said converted POS terminal data signals.

40. The method of claim 1, wherein each record in said lookup table has fields for at least product code, description of product, price 1 of product, price 2 of product, price 3 of product, price 4 of product, price 5 of product, price 6 of product, and sequence of keys pressed.

41. The method of claim 18, wherein a record in said lookup table database contains at least the fields product code, description of product, price 1 of product, price 2 of product, price 3 of product, price 4 of product, price 5 of product, price 6 of product, and sequence of keys pressed.

42. The method of claim 18, wherein said record in said purchase data database further comprises transaction ID, lane number, number of items purchased, price number, product description, time of transaction, time at a order station, time at a payment station, and time at a pickup station.

43. The method of claim 23, wherein said printer is designed or configured to communicate to each of two separate computers using one protocol for each of those computers.

44. A computer network system comprising:
a POS central computer;
an incentive central computer;
a POS terminal;
an incentive local computer;
a sniffer line;
a lookup table data structure associating data signals with product codes;
wherein said POS central computer is configured to transmit a lookup table having said lookup table data structure in association with a store identification to said incentive central computer;
wherein said incentive central computer is configured to transmit said lookup table to said incentive local computer for a store associated with said store identification; and
wherein said local incentive computer converts POS terminal data signals propagating on said sniffer line to product codes based at least in part on data stored in said lookup table stored in said local incentive computer.

45. The system of claim 44, wherein said POS central computer is configured to transmit data to said incentive central computer via a network.

46. The system of claim 45, wherein said network is the Internet.

47. The system of claim 45, wherein said network is a private digital corporate network.

48. The system of claim 45, wherein said network is a dial-up network.

49. The system of claim 45, wherein said POS central computer is configured to transmit said lookup table to said incentive central computer via said network.

50. The system of claim 44, wherein each record in said lookup table has fields for at least product code, description of product, price 1 of product, and sequence of keys pressed.

51. The system of claim 44, wherein said POS central computer comprises an associated central processor, memory, input, and output devices.

52. The system of claim 44, wherein said POS central computer is associated with a local store information database.

53. The system of claim 44, wherein said incentive central computer comprises an associated central processor, memory, input, and output devices.

54. The system of claim 44, wherein said incentive central computer is associated with a purchase data database configured to store purchase data and a criteria data database configured to store criteria applicable at least to purchase data.

55. The system of claim 44, wherein said incentive central computer is connected to said incentive local computer via a network.

56. The system of claim 55, wherein said incentive central computer is configured to transmit said lookup table to said incentive local computer via said network.

57. The system of claim 55, wherein said network wherein said network is the Internet.

58. The system of claim 55, wherein said network is a private digital corporate network.

59. The system of claim 55, wherein said network is a dial-up network.

60. The system of claim 44, wherein said incentive local computer comprises an associated central processor, memory, input, and output devices.

61. The system of claim 44, wherein said incentive local computer has a memory storing said lookup table, purchase data database to store purchase data and a criteria data database configured to store criteria applicable at least to purchase data.

62. The system of claim 61, wherein a record in said lookup table database contains at least the fields product code, description of product, price 1 of product, and sequence of keys pressed.

63. The system of claim 61, wherein a record in said purchase data database contains at least the fields consumer identification, product code, product purchase price, and date of transaction.

64. The system of claim 61, wherein a record in said criteria data database contains fields for at least: incentive description, incentive start date, incentive expiration date, product code, criteria for issuing incentive, and price number.

65. The system of claim 44, wherein said incentive local computer connects to a printer associated with at least one POS terminal.

66. The system of claim 65, wherein said printer is designed to communicate using at least two network protocols.

67. The system of claim 44, wherein said POS terminal data signals comprise data for transaction ID, lane number, sequence of keys for purchase, number of items in purchase data, and price number.

68. The system of claim 44, wherein said sniffer line is a line that connects to or otherwise detects said POS terminal data signals as a data stream being transmitted from a POS terminal to a POS computer.

69. The system of claim 68, wherein said POS terminal and said POS computer are connected by a POS terminal line that does not connect to a voltage divider so that there is minimal impedance on said POS terminal line.

70. The system of claim 68, wherein said sniffer line is configured to propagate said digital signal to an input of said incentive local computer.

71. The system of claim 44, wherein said product codes are defined by a corporation.

72. The system of claim 44, wherein said POS terminal data signals originate from a POS terminal.

73. The system of claim 72, wherein said POS terminal includes an image touch screen.

74. The system of claim 72, wherein said POS terminal connects to at least one of an order station sensor, a payment sensor, a pickup station sensor, a POS input device, an order station, a payment station, and a printer associated with a pickup station.

75. The system of claim 72, wherein said POS computer is associated with a POS database configured to store data received in at least one POS terminal.

76. The system of claim 72, wherein said POS computer comprises an associated central processor, memory, input, and output devices.

77. The system of claim 72, wherein said POS computer is connected to POS central computer via a network.

78. The system of claim 77, wherein said network is the Internet.

79. The system of claim 77, wherein said-network is a private digital corporate network.

80. The system of claim 77, wherein said network is a dial-up network.

81. The system of claim 44, wherein said incentive local computer is configured to analyze said converted POS terminal data signals.

82. The system of claim 81, wherein said incentive local computer is configured to generate an incentive based on said converted POS terminal data signals.

83. The system of claim 44, wherein each record in said lookup table has fields for at least product code, description of product, price 1 of product, price 2 of product, price 3 of product, price 4 of product, price 5 of product, price 6 of product, and sequence of keys pressed.

84. The system of claim 61, wherein a record in said lookup table database contains at least the fields product code, description of product, price 1 of product, price 2 of product, price 3 of product, price 4 of product, price 5 of product, price 6 of product, and sequence of keys pressed.

85. The system of claim 61, wherein said record in said purchase data database further comprises transaction ID, lane number, number of items purchased, price number, product description, time of transaction, time at a order station, time at a payment station, and time at a pickup station.

86. The system of claim 66, wherein said printer is designed or configured to communicate to each of two separate computers using one protocol for each of those computers.

87. A computer network implemented system comprising:
structure for transmitting a lookup table in association with a store identification from a POS central computer to an incentive central computer;
structure for transmitting said lookup table from said incentive central computer to an incentive local computer for a store associated with said store identification; and
structure for converting in said local incentive computer POS terminal data signals propagating on a sniffer line to product codes based at least in part on said lookup table stored in said local incentive computer.

88. A computer network implemented system comprising:
means for transmitting a lookup table in association with a store identification from a POS central computer to an incentive central computer;
means for transmitting said lookup table from said incentive central computer to an incentive local computer for a store associated with said store identification; and
means for converting in said local incentive computer POS terminal data signals propagating on a sniffer line to product codes based at least in part on said lookup table stored in said local incentive computer.

89. The method of claim 1, wherein a price number is selected based on said product code.

90. The system of claim 44, wherein a price number is selected based on said product code.
